(19) United States
(12) Patent Application Publication
(10) Pub. No.: US 2014/0265708 A1
(43) Pub. Date: Sep. 18, 2014

(54) DUAL MAGNETIC PHASE ROTOR LAMINATIONS FOR INDUCTION MACHINES

(71) Applicant: GENERAL ELECTRIC COMPANY, Schenectady, NY (US)

(72) Inventors: Steven Joseph Galioto, Niskayuna, NY (US); Ayman Mohamed Fawzi EL-Refaie, Niskayuna, NY (US)

(73) Assignee: General Electric Company, Schenectady, NY (US)

(21) Appl. No.: 13/853,122

(22) Filed: Mar. 29, 2013

Related U.S. Application Data
(60) Provisional application No. 61/785,020, filed on Mar. 14, 2013.

(51) Int. Cl. H02K 1/02

(52) U.S. Cl. CPC H02K 1/02
USPC 310/166

(57) ABSTRACT

A dual magnetic phase rotor lamination for use in induction machines is disclosed. A rotor assembly is provided that includes a rotor core and a plurality of rotor conductors mechanically coupled to the rotor core and positioned thereabout, with the plurality of rotor conductors positioned within slots formed in the rotor core. The rotor core comprises a plurality of rotor laminations that collectively form the rotor core, with each of the rotor laminations being composed of a dual magnetic phase material and including a first rotor lamination portion comprising a magnetic portion and a second rotor lamination portion comprising a non-magnetic portion, wherein the second rotor lamination portion comprises a treated portion of the rotor lamination that is rendered non-magnetic so as to adjust a leakage inductance of the induction machine.

### CROSS-REFERENCE TO RELATED APPLICATION

The present application is a non-provisional of, and claims priority to, U.S. Provisional Patent Application Ser. No. 61/785,020, filed Mar. 14, 2013, the disclosure of which is incorporated herein by reference.

### GOVERNMENT LICENSE RIGHTS

This invention was made with Government support under contract number DE-EE0005573 awarded by the United States Department of Energy. The Government has certain rights in the invention.

### BACKGROUND OF THE INVENTION

The invention relates generally to electrical machines and, more particularly, to a dual magnetic phase rotor lamination for use in induction machines.

The need for high power density and high efficiency electrical machines (i.e., electric motors and generators) has long been prevalent for a variety of applications, particularly for hybrid and/or electric vehicle traction applications. The current trend in hybrid/electric vehicle traction motor applications is to increase rotational speeds to increase the machine's power density, and hence reduce its mass and cost. However, it is recognized that when electrical machines are used for traction applications in hybrid/electric vehicles, there is a clear tradeoff between power density, efficiency, and the machine's constant power speed range—and that this tradeoff presents numerous design challenges.

With particular regard to the use of induction motors for traction applications in hybrid/electric vehicles, it can be seen in FIG. 1 that an induction motor operates within a narrow band of its torque-versus-slip capability curve 2 during rated operation. In order for the induction motor to achieve a large constant-power speed range, its breakdown torque capability must be sufficiently large such that it can produce the required torque at its top speed. As the motor's frequency (speed) increases, its breakdown torque capability decreases and thus the height of the torque-versus-slip curve highlighted in FIG. 1 decreases.

A description of how the maximum torque at breakdown is influenced by several characteristics of the motor can be set forth as:

$${T}_{max} = \frac{1}{2} * \frac{3 p}{ω} * \frac{{V}_{1}^{2}}{{R}_{1} + \sqrt{{R}_{1}^{2} + {X}_{L}^{2}}} , \qquad [ Eqn . 1 ]$$

where p is the motor's pole count, V₁ is the maximum voltage of the motor, w is the angular speed of the motor, R₁ is the stator winding resistance, and X_{L} is the motor leakage reactance per phase. The breakdown torque is thus directly proportional to the motor's pole count (p) and the square of the maximum voltage of the motor (V1), and it is inversely proportional to the angular speed (w) of the motor. Most importantly, it is inversely proportional to a combination of stator winding phase resistance (R1) and the overall motor leakage reactance (X_{L}) per phase.

As indicated in Equation 2, the phase leakage reactance is much larger than the phase resistance in a typical induction motor, according to:

X_{L}>>R₁∴R₁+\sqrt{R₁²+X_{L}²}≈X_{L} [Eqn. 2].

Therefore, the denominator of Error! Reference source not found. simplifies to the motor's leakage reactance according to:

X_{L}=ω*L_{L} [Eqn. 3].

Referring now to FIG. 2, the relationship between the leakage reactance and the stator winding resistance of an example induction motor design is shown. Note that, as indicated by curve 4, the leakage reactance increases with motor speed (frequency) because reactance is simply inductance multiplied by angular frequency, as shown in Error! Reference source not found. Additionally, it can be seen in FIG. 2 that the stator winding resistance, indicated as curve 5, is much lower than the leakage reactance of curve 4. As a result, the total leakage reactance (rotor plus stator) has a large effect on the motor's ability to achieve its rated power at its top speed.

FIG. 3 illustrates how the breakdown torque of an example induction motor design decreases rapidly, illustrated by curve 6 (and as compared to a required torque 8), as dictated by Error! Reference source not found. and Error! Reference source not found. Note that the required torque curve is determined by assuming a constant 30 kW output power requirement over the speed range shown in the figure.

Thus, as can be seen, the rotor slot leakage reactance in an induction motor plays a large role in limiting the high-speed power or torque capability of the induction motor—and it is therefore desirable to reduce the leakage reactance of the motor in order to improve the induction motor's high-speed torque capability. Various techniques for reducing the leakage reactance of the motor have previously been attempted; however, these techniques result in a sacrifice to the motor's efficiency or power density, or similar drawback to motor performance. These techniques (and associated drawbacks) include: (1) decreasing the stack length of the motor, which results in a decrease in motor efficiency; (2) decreasing the slot depth of the stator slots, which increases rotor bar losses and decreases motor efficiency; (3) eliminating any skew in the rotor or stator of the motor meant to decrease torque ripple—thus increasing the output torque ripple if the skew is removed; (4) decreasing the number of turns in the stator winding to decrease the end-winding leakage reactance contribution to the overall leakage reactance, such that, with fewer turns per phase, the stack length of the motor must increase to achieve the motor's desired voltage and power level; and (5) increasing the motor's maximum voltage to improve the high-speed torque capability without affecting the leakage reactance of the motor, with the drawback that, in many applications, there is a voltage limit that cannot be exceeded due to inverter or other system requirements. It is also recognized that open slots can be provided on the stator side to reduce slot leakage inductance and/or can be provided on the rotor side—but that this typically is not very practical, especially with the casting of the rotor cage.

Therefore, it would be desirable to provide an induction motor, and associated motor components, that provide for a reduced leakage reactance without an associated sacrifice to the motor's efficiency or power density.

### BRIEF DESCRIPTION OF THE INVENTION

The invention is directed to rotor laminations for an induction machine having a squirrel-cage rotor design. The rotor laminations are formed of a dual magnetic phase material and are treated such that portions of each rotor lamination are rendered non-magnetic, so as to minimize flux leakage in the rotor.

In accordance with one aspect of the invention, an induction machine includes a stator including a plurality of windings and being configured to generate a rotating magnetic field when a current is provided to the plurality of windings and a rotor assembly positioned within the stator and configured to rotate relative thereto responsive to the rotating magnetic field, with the rotor assembly including a rotor core and a plurality of rotor conductors mechanically coupled to the rotor core and positioned thereabout, with the plurality of rotor conductors positioned within slots formed in the rotor core. The rotor core comprises a plurality of rotor laminations that collectively form the rotor core, with each of the rotor laminations being composed of a dual magnetic phase material and including a first rotor lamination portion comprising a magnetic portion and a second rotor lamination portion comprising a non-magnetic portion, wherein the second rotor lamination portion comprises a treated portion of the rotor lamination, with the treating of the second rotor lamination portion rendering the dual magnetic phase material of the rotor lamination non-magnetic at the locations of the second rotor lamination portion, so as to adjust a leakage inductance of the induction machine.

In accordance with another aspect of the invention, a rotor assembly for an induction machine includes a rotor core having a plurality of slots formed therein that are enclosed within the rotor core by a plurality of slot closure portions of the rotor core and a plurality of rotor conductors coupled to the rotor core and positioned thereabout within the slots of the rotor core, with the plurality of rotor conductors enclosed within the rotor core by the plurality of slot enclosure portions. The rotor core comprises a plurality of integral, non-segmented rotor laminations that are stacked and joined to collectively form the rotor core, with each of the rotor laminations being composed of a dual magnetic phase material such that the slot closure portions of each rotor lamination are in a non-magnetic state and a remaining portion of each rotor lamination is in a magnetic state, with the non-magnetic slot closure portions reducing a leakage inductance of the rotor core.

In accordance with yet another aspect of the invention, a method for manufacturing an induction machine includes providing a stator including a plurality of windings thereon, with the stator being configured to generate a rotating magnetic field when a current is provided to the plurality of windings. The method also includes providing a rotor assembly for positioning within the stator that is configured to rotate relative thereto responsive to the rotating magnetic field, wherein providing the rotor assembly comprises providing a plurality of rotor laminations formed of a dual magnetic phase material that is magnetic in a first state and non-magnetic in a second state and having a plurality of slot closures positioned about a circumference thereof to define a plurality of slots in each rotor lamination, joining the plurality of rotor laminations to form a rotor core, the rotor core having a plurality of slots formed therein corresponding to the plurality of slots in the rotor laminations, and positioning a plurality of rotor conductors within slots defined in the rotor core, with the plurality of rotor conductors enclosed within the rotor core by the plurality of slot closures. The slot closures of each of the plurality of rotor laminations are in the second state so as to be non-magnetic and a remaining portion of the plurality of rotor laminations is in the first state so as to be magnetic.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 illustrates a torque vs. slip curve for an induction motor.

FIG. 2 illustrates a relationship between leakage reactance and stator winding resistance for an induction motor.

FIG. 3 illustrates a decrease in breakdown torque as compared to motor speed over the speed range of an induction motor.

FIG. 4 is a schematic perspective view of an overall induction machine in accordance with an embodiment of the invention.

FIG. 5 is a schematic diagram of a rotor lamination configuration for the induction machine of FIG. 4, positioned relative to a stator, according to an embodiment of the invention.

FIG. 6 is a detailed view of the rotor lamination of FIG. 5.

FIG. 7 is a schematic perspective view of an overall induction machine in accordance with another embodiment of the invention.

### DETAILED DESCRIPTION

Referring to FIGS. 4-6, an AC induction machine 10 (i.e., induction motor), and respective components thereof, is illustrated according to an embodiment of the invention. Induction motor 10 includes a stator 12 and a rotor assembly 14 (i.e., “rotor”). Stator 12 further includes a stator core 16 and windings 18 wound on the stator core 16. The stator core 16 has a core main body 20 formed, for example, by stacking a large number of annular-shaped thin plates (not shown) made of electromagnetic steel and insulators (not shown) provided on axial end surfaces of the core main body. The stator core 16 is provided with a plurality of teeth 22 at a predetermined pitch along a circumferential direction thereof. According to an exemplary embodiment, windings 18 are wound on the respective teeth 22, with slots 24 formed between adjacent teeth 22 along the circumferential direction.

As shown in FIG. 4, rotor assembly 14 is constructed as a squirrel-cage type rotor that includes a rotor core 26, end rings 27, and a number of rotor bars 28 coupled to the rotor core 26 and extending between the end rings. The rotor core 26 is not formed as a single, solid machined piece, but instead is comprised of a plurality of thin plate rotor laminations that are stacked axially and pressed to form the rotor, with such a rotor lamination 30 being shown in FIGS. 5 and 6. As shown in FIGS. 5 and 6, each of the laminations 30 is formed of a material that can be stamped or cut, for example, to form the metallic laminations. The rotor bars 28 of the rotor assembly 14 are positioned within slots 32 formed in the rotor core 26 (i.e., the slots 32 in each lamination 30) and can be formed either as solid copper bars that are inserted into the slots and brazed to two solid copper end-rings at either end of the rotor, or can be casted out of aluminum or copper using the assembled rotor core as the mold for the bar sections of the cage.

In operation of AC induction motor 10, an excitation current is provided to stator 12 such that current flows through stator windings 18. The flow of current through windings 18 creates a rotating magnetic field in an air gap (not shown) between the stator 12 and rotor 14 that induces current flow through rotor bars 28. These currents interact with the rotating magnetic field created by the stator 12 and, in effect, cause a rotational motion on the rotor 14. According to embodiments of the invention, asynchronous motor 10 may be in the form of 3-phase motor, however, it is recognized that motor 10 could also be in the form of a single phase motor or another multi-phase motor.

As shown in FIGS. 5 and 6, it is seen that the rotor core 26 also includes slot closures 34 positioned about a circumference of the rotor core 26 (i.e., each lamination 30) that function to contain the rotor bars 28 within the slots 32 of the rotor core, as without these slot closures 34 the rotor bars are only held in place by the end-rings 27 (FIG. 4) of the rotor cage. The slot closures 34 are located in areas radially outward of the rotor bars 28 and function to provide structural integrity to each lamination 30 of the rotor core 26 and minimize the movement or vibration of the rotor bars 28 within their slots 32. It is recognized, however, that the slot closures 34 also serve as a path for flux leakage around the rotor bars. Thus, these areas increase the overall leakage inductance of the motor—and thus the reactance, since reactance is a product of inductance and angular frequency. This leakage reactance component is referred to as a “rotor slot leakage reactance.”

In order to minimize the amount of rotor slot leakage reactance that occurs through the slot closures 34, the rotor core 26 (i.e., each of the laminations 30 used to form the rotor core) is composed of a dual magnetic phase material, such as a silicon-steel-chromium material or another suitable material, that can be selectively treated to form magnetic portions and non-magnetic portions in the lamination. For example, the dual magnetic phase material can initially have magnetic properties, with a heat treating being applied to desired areas of the lamination 30 to render those areas non-magnetic and thereby minimize magnetic leakage flux through the non-magnetic areas. It is recognized, however, that other processes/treatments could be employed to render areas of the lamination 30 non-magnetic, such as mechanical stress or nitriding treatments.

According to an exemplary embodiment of the invention, the slot closures 34 positioned radially outward of the rotor bars 28 are treated to render them non-magnetic. By rendering the slot closures 34 non-magnetic, the flux leakage through the slot closures 34 is minimized and the leakage inductance due to the rotor slots 32 is thus minimized in these areas. The non-magnetic slot closures 34 thus serve to minimize the rotor slot leakage inductance and thereby also reduce the overall leakage reactance of the induction motor 10.

While the induction machine 10 of FIGS. 4-6 is shown as including a squirrel-cage rotor, it is recognized that an embodiment of the invention could instead be constructed as an induction machine having a wound field rotor. Referring now to FIG. 7, an induction machine 40 is shown that includes a wound field rotor 42 having a plurality of conductive wires 44 wound within slots 32 formed in a rotor core 26. Similar to the squirrel-cage rotor (FIGS. 4-6), the rotor core 26 in the wound field rotor induction motor 40 is formed of a plurality of laminations 30 each formed of a dual magnetic phase material, with slot closures 34 of the rotor core 26 being selectively treated to render the slot closures 34 non-magnetic and thereby minimize magnetic leakage flux there through so as to also thereby minimize leakage inductance of the induction machine 40.

Beneficially, embodiments of the invention thus provide an induction machine 10, 40 having rotor laminations 30 formed of a dual magnetic phase material. The dual magnetic phase material of the rotor laminations 30 can be treated to make portions of the rotor lamination non-magnetic. Specifically, slot closures 34 on the rotor lamination 30 that are positioned radially outward of the rotor bars 28 can be made non-magnetic. By making the slot closures 34 non-magnetic, the flux leakage path around the rotor bars 28 and through the slot closures 34 is minimized, so as to increase the high-speed power and torque capability of the induction machine without sacrificing power density or efficiency. A wide constant power speed range can thus be achieved for induction motors used in variable speed applications.

In using dual magnetic phase material for the rotor lamination 30, the non-magnetic slot closures 34 can be made thick as needed for mechanical robustness without having to worry about increasing the size of a potential flux path. Additionally, when using dual magnetic phase material for the rotor lamination 30, the lamination can be cut as one whole lamination (i.e., integral) without segmentation (i.e., adding a separate nonmagnetic wedge as a slot closure), so as to reduce the cost of the laminations 30 and the overall rotor core 26 since there is no need to assemble several separate lamination segments/components. While rotor laminations 30 constructed of a dual magnetic phase material have been previously available, they have not been included in induction motors for purposes of adjusting the leakage inductance of the motor, with the non-magnetic portions (i.e., slot closures 34) functioning to minimize flux leakage around the rotor bars 28—so as to provide or a machine having constant output power over a wide speed range, as compared to prior art induction machines.

Therefore, according to one embodiment of the invention, an induction machine includes a stator including a plurality of windings and being configured to generate a rotating magnetic field when a current is provided to the plurality of windings and a rotor assembly positioned within the stator and configured to rotate relative thereto responsive to the rotating magnetic field, with the rotor assembly including a rotor core and a plurality of rotor conductors mechanically coupled to the rotor core and positioned thereabout, with the plurality of rotor conductors positioned within slots formed in the rotor core. The rotor core comprises a plurality of rotor laminations that collectively form the rotor core, with each of the rotor laminations being composed of a dual magnetic phase material and including a first rotor lamination portion comprising a magnetic portion and a second rotor lamination portion comprising a non-magnetic portion, wherein the second rotor lamination portion comprises a treated portion of the rotor lamination, with the treating of the second rotor lamination portion rendering the dual magnetic phase material of the rotor lamination non-magnetic at the locations of the second rotor lamination portion, so as to adjust a leakage inductance of the induction machine.

According to another embodiment of the invention, a rotor assembly for an induction machine includes a rotor core having a plurality of slots formed therein that are enclosed within the rotor core by a plurality of slot closure portions of the rotor core and a plurality of rotor conductors coupled to the rotor core and positioned thereabout within the slots of the rotor core, with the plurality of rotor conductors enclosed within the rotor core by the plurality of slot enclosure portions. The rotor core comprises a plurality of integral, non-segmented rotor laminations that are stacked and joined to collectively form the rotor core, with each of the rotor laminations being composed of a dual magnetic phase material such that the slot closure portions of each rotor lamination are in a non-magnetic state and a remaining portion of each rotor lamination is in a magnetic state, with the non-magnetic slot closure portions reducing a leakage inductance of the rotor core.

According to yet another embodiment of the invention, a method for manufacturing an induction machine includes providing a stator including a plurality of windings thereon, with the stator being configured to generate a rotating magnetic field when a current is provided to the plurality of windings. The method also includes providing a rotor assembly for positioning within the stator that is configured to rotate relative thereto responsive to the rotating magnetic field, wherein providing the rotor assembly comprises providing a plurality of rotor laminations formed of a dual magnetic phase material that is magnetic in a first state and non-magnetic in a second state and having a plurality of slot closures positioned about a circumference thereof to define a plurality of slots in each rotor lamination, joining the plurality of rotor laminations to form a rotor core, the rotor core having a plurality of slots formed therein corresponding to the plurality of slots in the rotor laminations, and positioning a plurality of rotor conductors within slots defined in the rotor core, with the plurality of rotor conductors enclosed within the rotor core by the plurality of slot closures. The slot closures of each of the plurality of rotor laminations are in the second state so as to be non-magnetic and a remaining portion of the plurality of rotor laminations is in the first state so as to be magnetic.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An induction machine comprising:
a stator including a plurality of windings and being configured to generate a rotating magnetic field when a current is provided to the plurality of windings; and
a rotor assembly positioned within the stator and configured to rotate relative thereto responsive to the rotating magnetic field, the rotor assembly comprising:
a rotor core; and
a plurality of rotor conductors mechanically coupled to the rotor core and positioned thereabout, with the plurality of rotor conductors positioned within slots formed in the rotor core;
wherein the rotor core comprises a plurality of rotor laminations that collectively form the rotor core, with each of the rotor laminations being composed of a dual magnetic phase material and including:
a first rotor lamination portion comprising a magnetic portion; and
a second rotor lamination portion comprising a non-magnetic portion;
wherein the second rotor lamination portion comprises a treated portion of the rotor lamination, with the treating of the second rotor lamination portion rendering the dual magnetic phase material of the rotor lamination non-magnetic at the locations of the second rotor lamination portion, so as to adjust a leakage inductance of the induction machine.

2. The induction machine of claim 1 wherein the second lamination portion comprises a plurality of slot closures positioned adjacent the plurality of rotor conductors and radially outward therefrom, with each slot closure being non-magnetic.

3. The induction machine of claim 2 wherein the non-magnetic slot closures minimize a flux leakage there through so as to minimize rotor slot leakage reactance.

4. The induction machine of claim 3 wherein minimizing of the rotor slot leakage reactance provides for increased high-speed power and torque capability in the induction machine and for constant output power over a wide speed range.

5. The induction machine of claim 2 wherein the plurality of slot closures of the rotor core serve to completely enclose the plurality of rotor conductors within the slots of the rotor core.

6. The induction machine of claim 1 wherein each of the plurality of rotor laminations comprises an integral, non-segmented rotor lamination formed as a single piece from the dual magnetic phase material.

7. The induction machine of claim 1 wherein the second rotor lamination portion of the rotor lamination comprises one of a heat treated portion, a portion having a nitriding treatment performed thereon, or a portion having mechanical stress applied thereto.

8. The induction machine of claim 1 wherein the plurality of rotor conductors comprise a plurality of rotor bars, and wherein the rotor assembly further comprises an end ring positioned on each end of the rotor core, with the end rings being coupled to the plurality of rotor bars to form a squirrel cage rotor.

9. The induction machine of claim 1 wherein the plurality of rotor conductors comprise a plurality of wires wound on the rotor core so as to be positioned in the slots formed in the rotor core, so as to form a wound field rotor.

10. A rotor assembly for an induction machine, the rotor assembly comprising:
a rotor core having a plurality of slots formed therein, the slots being enclosed within the rotor core by a plurality of slot closure portions of the rotor core;
a plurality of rotor conductors coupled to the rotor core and positioned thereabout within the slots of the rotor core, with the plurality of rotor conductors enclosed within the rotor core by the plurality of slot enclosure portions;
wherein the rotor core comprises a plurality of integral, non-segmented rotor laminations that are stacked and joined to collectively form the rotor core, with each of the rotor laminations being composed of a dual magnetic phase material; and
wherein the slot closure portions of each rotor lamination are in a non-magnetic state and a remaining portion of each rotor lamination is in a magnetic state, such that the non-magnetic slot closure portions reduce a leakage inductance of the rotor core.

11. The rotor lamination of claim 10 wherein the slot closure portions comprise treated portions of the rotor lamination, with the treating of the slot closure portions rendering the dual magnetic phase material of the rotor lamination non-magnetic at the slot closure portions.

12. The rotor lamination of claim 10 wherein the non-magnetic slot closure portions minimize a flux leakage through the slot closure portions, so as to minimize rotor slot leakage inductance in the rotor assembly.

13. The rotor lamination of claim 10 wherein reducing the leakage inductance of the rotor core provides for increased high-speed power and torque capability in the induction machine.

14. The rotor lamination of claim 10 wherein reducing the leakage inductance of the rotor core provides for constant output power over a wide speed range.

15. The rotor lamination of claim 10 wherein the plurality of rotor conductors comprise one of rotor bars wires wound on the rotor core, such that the rotor assembly comprises one of a squirrel cage rotor assembly and a wound field rotor assembly, respectively.

16. A method for manufacturing an induction machine, the method comprising:
providing a stator including a plurality of windings thereon, the stator being configured to generate a rotating magnetic field when a current is provided to the plurality of windings;
providing a rotor assembly for positioning within the stator that is configured to rotate relative thereto responsive to the rotating magnetic field, wherein providing the rotor assembly comprises:
providing a plurality of rotor laminations formed of a dual magnetic phase material that is magnetic in a first state and non-magnetic in a second state, each of the plurality of rotor laminations having a plurality of slot closures positioned about a circumference thereof to define a plurality of slots in each rotor lamination;
joining the plurality of rotor laminations to form a rotor core, the rotor core having a plurality of slots formed therein corresponding to the plurality of slots in the rotor laminations; and
positioning a plurality of rotor conductors within slots defined in the rotor core, with the plurality of rotor conductors enclosed within the rotor core by the plurality of slot closures; and
wherein the slot closures of each of the plurality of rotor laminations are in the second state so as to be non-magnetic and a remaining portion of the plurality of rotor laminations is in the first state so as to be magnetic.

17. The method of claim 16 further comprising treating the plurality of slot closures on each of the plurality of rotor laminations so as to cause the slot closures to transition from the first state to the second state, such that the slot closures are non-magnetic.

18. The method of claim 17 wherein treating the slot closures of the rotor laminations comprises one of heat treating, nitriding or applying mechanical stress to render the slot closure non-magnetic minimizes leakage inductance in the rotor assembly.

19. The method of claim 17 wherein treating the slot closures of the rotor laminations to render the slot closure non-magnetic minimizes leakage inductance in the rotor assembly so as to provide for increased high-speed power and torque capability in the induction machine and constant output power over a wide speed range.

20. The method of claim 16 wherein minimizing of the leakage inductance provides for constant output power over a wide speed range.
